(19) United States
(12) Patent Application Publication
(10) Pub. No.: US 2023/0388161 A1
(43) Pub. Date: Nov. 30, 2023

(54) TRANSMISSION CIRCUIT, ELECTRONIC CONTROL UNIT, AND VEHICLE

(71) Applicant: ROHM CO., LTD., Kyoto (JP)

(72) Inventors: Toru MUKAI, Kyoto (JP); Shinya MASUDA, Kyoto (JP)

(21) Appl. No.: 18/449,780

(22) Filed: Aug. 15, 2023

Related U.S. Application Data
(63) Continuation of application No. PCT/JP2022/002572, filed on Jan. 25, 2022.

(30) Foreign Application Priority Data
Mar. 1, 2021 (JP) 2021-031694

(51) Int. Cl. H04L 25/02

(52) U.S. Cl. CPC H04L 25/0272; H04L 25/0278

(57) ABSTRACT

A transmission circuit includes a first terminal to which a first voltage is applied, a second terminal, a third terminal, and a fourth terminal to which a second voltage lower than the first voltage is applied. The transmission circuit further includes a first variable resistance circuit between the first and second terminals, a second variable resistance circuit between the third and fourth terminals, and a controller that controls the resistance values of the first and second variable resistance circuits based on transmission data. The first and second variable resistance circuits are each a parallel circuit of a plurality of series circuits of a resistor and a switch. The first and second variable resistance circuits each include a charge adjuster that absorbs and discharges electric charge with respect to at least some of a plurality of switches.

### CROSS-REFERENCE TO RELATED APPLICATIONS

This nonprovisional application is a continuation application of International Patent Application No. PCT/JP2022/002572 filed on Jan. 25, 2022, which claims priority Japanese Patent Application No. 2021-031694 filed in Japan on Mar. 1, 2021, the entire contents of which are hereby incorporated by reference.

### BACKGROUND OF THE INVENTION

### 1. Technical Field

The invention disclosed herein relates to transmission circuits that transmit a differential signal, and also relates to electronic control units and vehicles that incorporate such transmission circuits.

### 2. Description of Related Art

Vehicles such as automobiles incorporate a number of electronic control units (ECUs). Communication among a number of ECUs is achieved by, for example, CAN (controller area network) communication (see, e.g., Japanese Unexamined Patent Application Publication No. S61-195453).

In CAN communication, transmitted and received signals are each a differential signal. A differential signal is composed of a first signal and a second signal and can be decomposed into a common-mode component and a differential-mode component.

The common-mode component is the average of the first and second signals, and the differential-mode component is the difference between the first and second signals.

### BRIEF DESCRIPTION OF THE DRAWINGS

FIG. 1 is an exterior view of a vehicle according to one embodiment.

FIG. 2 is a schematic diagram of a CAN communication system.

FIG. 3 is a diagram showing one configuration example of an ECU.

FIG. 4 is a diagram showing one configuration example of a transceiver circuit.

FIG. 5 is a timing chart showing a differential signal.

FIG. 6 is a diagram showing a first configuration example of a first variable resistance circuit.

FIG. 7 is a diagram showing a first configuration example of a second variable resistance circuit.

FIG. 8 is a diagram showing a second configuration example of the first variable resistance circuit.

FIG. 9 is a diagram showing a second configuration example of the second variable resistance circuit.

FIG. 10 is a diagram showing a third configuration example of the first variable resistance circuit.

FIG. 11 is a diagram showing a third configuration example of the second.

### DETAILED DESCRIPTION

In the present description, a MOS transistor denotes a transistor of which the gate has a structure composed of at least three layers which are: a layer of a conductor or a semiconductor with a low resistance value such as polysilicon; a layer of an insulator; and a layer of a P-type, N-type, or intrinsic semiconductor. That is, a MOS transistor may have any gate structure other than a three-layer structure of metal, oxide, and semiconductor.

In the present description, a constant current denotes a current that is constant under ideal conditions and may be a current that can vary slightly with change in temperature and the like.

In the present description, a constant voltage denotes a voltage that is constant under ideal conditions and may be a voltage that can vary slightly with change in temperature and the like.

<Vehicle and CAN Communication System>

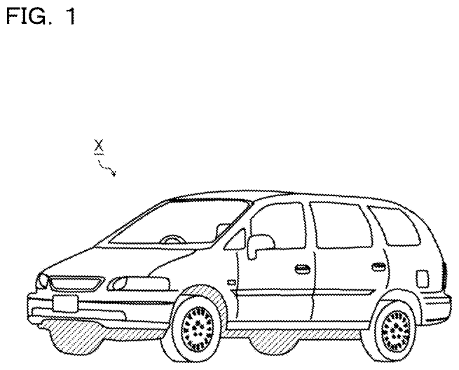

FIG. 1 is an exterior view of a vehicle X according to one embodiment. The vehicle X incorporates a plurality of ECUs (not shown in FIG. 1). The vehicle X also incorporates a battery (not shown).

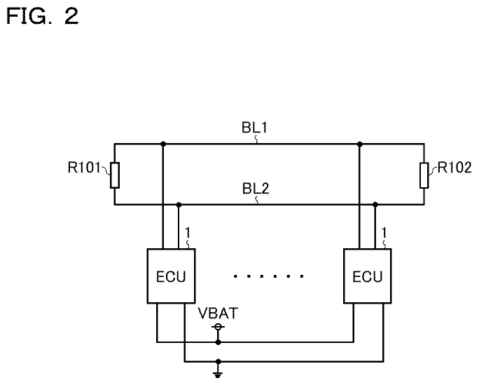

FIG. 2 is a schematic diagram of a CAN communication system provided in the vehicle X. The CAN communication system shown in FIG. 2 includes a plurality of ECUs 1, a first bus line BL1, a second bus line BL2, and resistors R101 and R102.

To one terminal of the first bus line BL1, one terminal of the resistor R101 is connected; to the other terminal of the first bus line BL1, one terminal of the resistor R102 is connected. To one terminal of the second bus line BL2, the other terminal of the resistor R101 is connected; to the other terminal of the second bus line BL2, the other terminal of the resistor R102 is connected. The plurality of ECUs 1 are each connected to the first and second bus lines BL1 and BL2. The battery outputs a voltage VBAT, which is supplied to each of the plurality of ECUs 1. The plurality of ECUs 1 are each connected to a ground potential. The plurality of ECUs 1 use the voltage VBAT as their supply voltage.

<ECU>

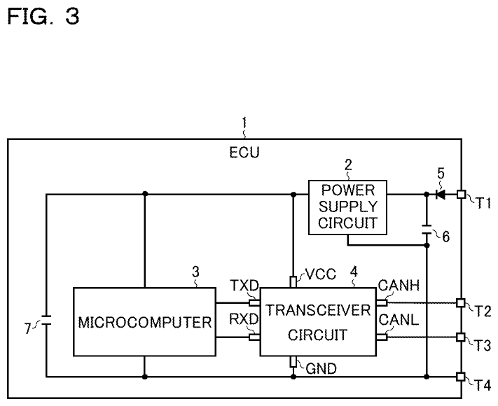

FIG. 3 is a diagram showing one configuration example of an ECU 1. The ECU 1 of the configuration example shown in FIG. 3 includes terminals T1 to T4, a power supply circuit 2, a microcomputer 3, a transceiver circuit 4, a diode 5, and capacitors 6 and 7.

The terminal T1 is fed with the voltage VBAT. The anode of the diode 5 is connected to the terminal T1. The cathode of the diode 5 is connected to the input terminal of the power supply circuit 2 and to the capacitor 6.

The output terminal of the power supply circuit 2 is connected to the supply voltage input terminal of the microcomputer 3, to a terminal VCC of the transceiver circuit 4, and to one terminal of the capacitor 7. The output terminal of the power supply circuit 2 outputs a constant voltage.

The microcomputer 3 transmits transmission data to a terminal TXD of the transceiver circuit 4, and receives reception data from a terminal RXD of the transceiver circuit 4. The transmission data and the reception data are each in the form of a single signal.

A terminal CANH of the transceiver circuit 4 is connected to the terminal T2, and a terminal CANL of the transceiver circuit 4 is connected to the terminal T3. The terminal T2 is connected to the first bus line BL1 shown in FIG. 2, and the terminal T3 is connected to the second bus line BL2 shown in FIG. 2.

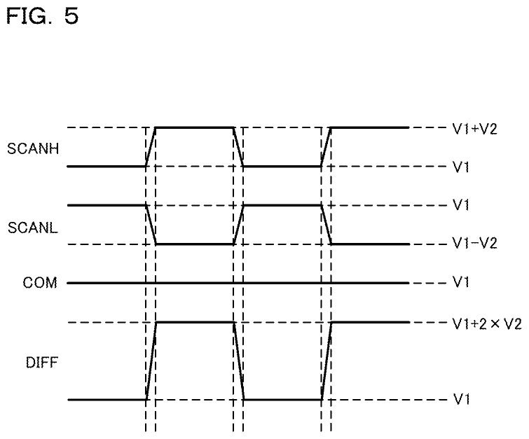

The transceiver circuit 4 transmits the transmission data in a form converted into a differential signal (CAN signal) composed of a first signal SCANH (see FIG. 5, referred to later) and a second signal SCANL (see FIG. 5, referred to later). The transceiver circuit 4 outputs, in a form converted into the reception data, a differential signal (CAN signal) composed of a first signal and a second signal. Thus the transceiver circuit 4 includes a transmission circuit that transmits a differential signal and a reception circuit that receives a differential signal. The first signal is transmitted across the first bus line BL1, and the second signal is transmitted across the second bus line BL2.

The ground terminal of the power supply circuit 2 is connected to the other terminal of the capacitor 6, to the terminal T4, to a terminal GND of the transceiver circuit 4, to the ground terminal of the microcomputer 3, and to the other terminal of the capacitor 7. The terminal T4 is connected to the ground potential.

<Transceiver Circuit>

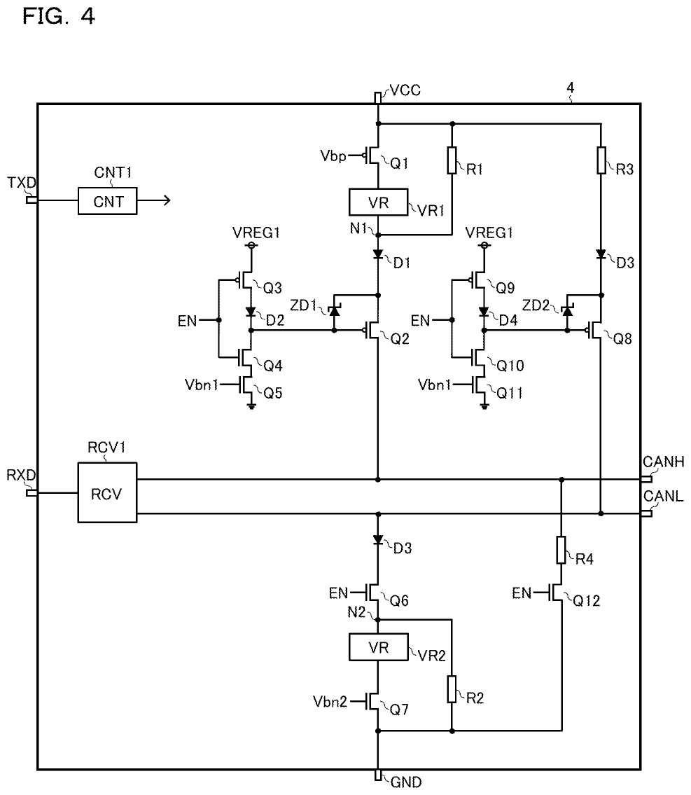

FIG. 4 is a diagram showing one configuration example of the transceiver circuit 4. The transceiver circuit 4 of the configuration example shown in FIG. 4 has terminals VCC, GND, TXD, RXD, CANH, and CANL.

The transceiver circuit 4 of the configuration example shown in FIG. 4 includes a first variable resistance circuit VR1, a second variable resistance circuit VR2, a P-channel MOS transistor (PMOS transistor) Q1 as a first current limiter, an N-channel MOS transistor (NMOS transistor) Q7 as a second current limiter, and a controller CNT1.

The transceiver circuit 4 of the configuration example shown in FIG. 4 also includes a pull-up resistor R1, a pull-down resistor R2, reverse-current prevention diodes D1 and D3, and a PMOS transistor Q2 and an NMOS transistor Q6 as clamping elements.

When the first variable resistance circuit VR1 is in a high-impedance state, the pull-up resistor R1 stabilizes the potential at a node N1 (the connection node between the first variable resistance circuit VR1 and the diode D1). When the second variable resistance circuit VR2 is in a high-impedance state, the pull-down resistor R2 stabilizes the potential at a node N2 (the connection node between the second variable resistance circuit VR2 and the NMOS transistor Q6).

The PMOS transistor Q2 and the NMOS transistor Q6 are double-diffused MOS transistors with high withstand voltages. The PMOS transistor Q2 clamps the source potential of the PMOS transistor Q2, and the NMOS transistor Q6 clamps the source potential of the NMOS transistor Q6.

The transceiver circuit 4 of the configuration example shown in FIG. 4 includes a receiver circuit RCV1, a diode D2, a PMOS transistor Q3, an NMOS transistor Q4, an NMOS transistor Q5, and a Zener diode ZD1.

The terminal VCC is connected to the source of the PMOS transistor Q1 and to one terminal of the pull-up resistor R1. The gate of the PMOS transistor Q1 is fed with a bias voltage Vbp, which is a constant voltage. Thus the PMOS transistor Q1 serves as a constant-current source. If the terminal CANH is short-circuited to a voltage equal to or lower than the voltage applied to the terminal GND, the PMOS transistor Q1 limits the current from the terminal VCC to the terminal CANH. In this way it is possible to suppress an overcurrent from the terminal VCC to the terminal CANH.

The drain of the PMOS transistor Q1 is connected to one terminal of the first variable resistance circuit VR1. The other terminal of the first variable resistance circuit VR1 is connected to the other terminal of the pull-up resistor R1 and to the anode of the diode D1 The cathode of the diode D1 is connected to the source of the PMOS transistor Q2.

The drain of the PMOS transistor Q2 is connected to the terminal CANH and to a first input terminal of the receiver circuit RCV1.

The PMOS transistor Q3, the NMOS transistor Q4, the NMOS transistor Q5, the diode D2, and the Zener diode ZD1 constitute a gate driving signal generation circuit, which generates a gate driving signal for the PMOS transistor Q2. The source of the PMOS transistor Q3 is fed with an internal voltage VREG1 generated within the transceiver circuit 4. The drain of the PMOS transistor Q3 is connected to the anode of the diode D2. The cathode of the diode D2 is connected to the anode of the Zener diode ZD1 and to the drain of the NMOS transistor Q4. The cathode of the Zener diode ZD1 is connected to the source of the PMOS transistor Q1. The gates of the PMOS transistor Q3 and the NMOS transistor Q4 are fed with an enable signal EN. When the enable signal EN is at high level, the transceiver circuit 4 is in an enabled state; when the enable signal EN is at low level, the transceiver circuit 4 is in a disabled state. The source of the NMOS transistor Q4 is connected to the drain of the NMOS transistor Q5. The source of the NMOS transistor Q5 is connected to the ground potential. The gate of the NMOS transistor Q5 is fed with a bias voltage Vbn1, which is a constant voltage.

The anode of the diode D3 is connected to the terminal CANL and to a second input terminal of the receiver circuit RCV1. The cathode of the diode D3 is connected to the drain of the NMOS transistor Q6. The source of the NMOS transistor Q6 is connected to one terminal of the second variable resistance circuit VR2 and to one terminal of the pull-down resistor R2. The gate of the NMOS transistor Q6 is fed with the enable signal EN.

The other terminal of the second variable resistance circuit VR2 is connected to the drain of the NMOS transistor Q7. The source of the NMOS transistor Q7 is connected to the other terminal of the pull-down resistor R2 and to the terminal GND. The gate of the NMOS transistor Q7 is fed with a bias voltage Vbn2, which is a constant voltage. Thus the NMOS transistor Q7 serves as a constant-current source. If the terminal CANL is short-circuited to a voltage equal to or higher than the voltage supplied to the terminal VCC, the NMOS transistor Q7 limits the current from the terminal CANL to the terminal GND. In this way it is possible to suppress an overcurrent from the terminal CANL to the terminal GND.

The controller CNT1 receives the transmission data fed to the terminal TXD and based on the transmission data controls the resistance values of the first and second variable resistance circuits VR1 and VR2.

As shown in FIG. 5, the first signal SCANH mentioned above is a binary signal between V1 and (V1+V2) and the second signal SCANL mentioned above is a binary signal between V1 and (V1−V2). The differential signal (CAN signal) composed of the first and second signals SCANH and SCANL can be decomposed into a common-mode component COM, which is the average of the first and second signals SCANH and SCANL, and a differential-mode component DIFF, which is the difference between the first and second signals SCANH and SCANL.

A time lag (skew) between the first and second signals SCANH and SCANL produces noise in the common-mode component COM. This skew-induced common-mode noise can be suppressed by giving the first and second signals SCANH and SCANL waveforms containing small high-frequency components.

To achieve that, in the transceiver circuit 4 of the configuration example shown in FIG. 4, during a first transition period in which the voltage value of the first signal SCANH changes from V1 to (V1+V2) and during a second transition period in which the voltage value of the second signal SCANL changes from V1 to (V1−V2), the resistance value of the first variable resistance circuit VR1 is decreased gradually and, during a third transition period in which the voltage value of the first signal SCANH changes from (V1+V2) to V1 and during a fourth transition period in which the voltage value of the second signal SCANL changes from (V1-V2) to V1, the resistance value of the first variable resistance circuit VR1 is increased gradually, so that the first and second signals SCANH and SCANL have waveforms containing small high-frequency components. Except during the transition periods mentioned above, the controller CNT1 keeps the resistance value of the first variable resistance circuit VR1 at its maximum value.

Likewise, in the transceiver circuit 4 of the configuration example shown in FIG. 4, during the first transition period in which the voltage value of the first signal SCANH changes from V1 to (V1+V2) and during the second transition period in which the voltage value of the second signal SCANL changes from V1 to (V1−V2), the resistance value of the second variable resistance circuit VR2 is decreased gradually and, during the third transition period in which the voltage value of the first signal SCANH changes from (V1+V2) to V1 and during the fourth transition period in which the voltage value of the second signal SCANL changes from (V1−V2) to V1, the resistance value of the second variable resistance circuit VR2 is increased gradually, so that the first and second signals SCANH and SCANL have waveforms containing small high-frequency components. Except during the transition periods mentioned above, the controller CNT1 keeps the resistance value of the second variable resistance circuit VR2 at its maximum value.

The transceiver circuit 4 of the configuration example shown in FIG. 4 further includes resistors R3 and R4, diodes D3 and D4, PMOS transistors Q8 and Q9, NMOS transistors Q10 to Q12, and a Zener diode ZD2. These components constitute a dummy circuit, which improves the symmetry between the first and second signals SCANH and SCANL.

One terminal of the resistor R3 is connected to the terminal VCC. The other terminal of the resistor R3 is connected to the anode of the diode D3. The cathode of the diode D3 is connected to the source of the PMOS transistor Q8. The drain of the PMOS transistor Q8 is connected to the terminal CANL.

The PMOS transistor Q9, the diode D4, the NMOS transistor Q10, the NMOS transistor Q11, and the Zener diode ZD2 constitute a gate driving signal generation circuit, which generates a gate driving signal for the PMOS transistor Q8. The source of the PMOS transistor Q9 is fed with the internal voltage VREG1 generated within the transceiver circuit 4. The drain of the PMOS transistor Q9 is connected to the anode of the diode D4, and the cathode of the diode D4 is connected to the anode of the Zener diode ZD2 and to the drain of the NMOS transistor Q10. The cathode of the Zener diode ZD2 is connected to the source of the PMOS transistor Q8. The gates of the PMOS transistor Q9 and the NMOS transistor Q10 are fed with the enable signal EN. The source of the NMOS transistor Q10 is connected to the drain of the NMOS transistor Q11. The source of the NMOS transistor Q11 is connected to the ground potential. The gate of the NMOS transistor Q11 is fed with the bias voltage Vbn1, which is a constant voltage.

One terminal of the resistor R4 is connected to the terminal CANH. The other terminal of the resistor R4 is connected to the drain of the NMOS transistor Q12. The source of the NMOS transistor Q12 is connected to the terminal GND. The gate of the NMOS transistor Q12 is fed with the enable signal EN.

The dummy circuit described above does improve the symmetry between the first and second signals SCANH and SCANL, but not necessarily sufficiently. As a solution, in the embodiment, the first and second variable resistance circuits VR1 and VR2 are configured ingeniously so as to improve the symmetry between the first and second signals SCANH and SCANL.

A description will now be given of configuration examples of the first and second variable resistance circuits VR1 and VR2 that can improve the symmetry between the first and second signals SCANH and SCANL.

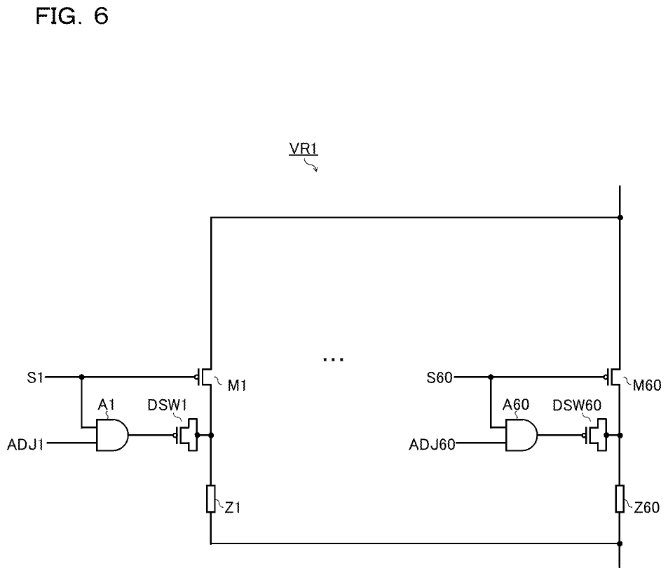

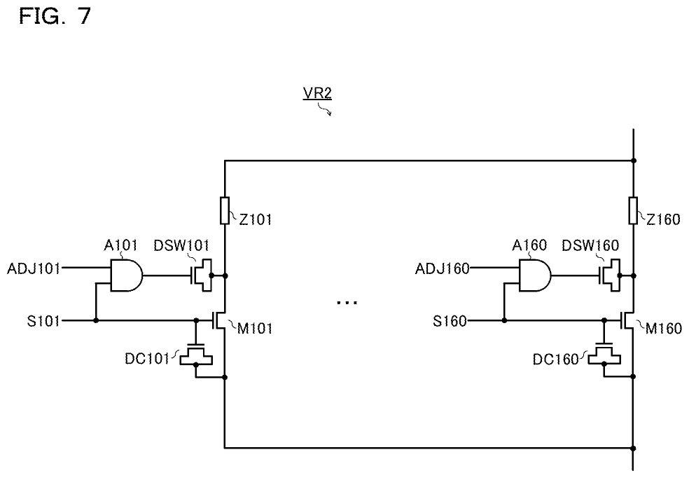

FIG. 6 is a diagram showing a first configuration example of the first variable resistance circuit VR1 and FIG. 7 is a diagram showing a first configuration example of the second variable resistance circuit VR2. The first variable resistance circuit VR1 of the first configuration example shown in FIG. 6 and the second variable resistance circuit VR2 of the first configuration example shown in FIG. 7 are paired in use.

The first variable resistance circuit VR1 of the first configuration example shown in FIG. 6 includes PMOS transistors M1 to M60, as switches, and resistors Z1 to Z60, and is a parallel circuit of 60 series circuits of a resistor and a switch. The PMOS transistors M1 to M60 are turned on and off with control signals S1 to S60 output from the controller CNT1. There may be provided any number other than 60 of the series circuits above. In the configuration example shown in FIG. 6, the combined resistance of the resistors Z1 to Z60 determines the resistance value of the first variable resistance circuit VR1, and this permits accurate control of the resistance value of the first variable resistance circuit VR1.

The first variable resistance circuit VR1 of the first configuration example shown in FIG. 6 further includes dummy switches DSW1 to DSW60 and AND gates A1 to A60. The dummy switches DSW1 to DSW60 serve as charge adjusters that can absorb and discharge electric charge with respect to the PMOS transistors M1 to M60 respectively. The dummy switch DSW1 is a PMOS transistor of which the source and the drain are short-circuited together and connected to the drain of the PMOS transistor M1. When the PMOS transistor M1 is on, the dummy switch DSW1 can turn on. The AND gate A1 feeds the AND of the control signal S1 and an adjustment signal ADJ1 to the gate of the dummy switch DSW1. Thus, when the adjustment signal ADJ1 is at high level, the dummy switch DSW1 can absorb and discharge electric charge with respect to the PMOS transistor M1. By contrast, when the adjustment signal ADJ1 is at low level, the dummy switch DSW1 cannot absorb or discharge electric charge with respect to the PMOS transistor M1.

The dummy switches DSW2 to DSW60 and the AND gates A2 to A60 are similar to the dummy switch DSW1 and the AND gate A1, and therefore of those no detailed description will be given.

The second variable resistance circuit VR2 of the first configuration example shown in FIG. 7 includes NMOS transistors M101 to M160, as switches, and resistors Z101 to Z160, and is a parallel circuit of 60 series circuits of a resistor and a switch. The NMOS transistors M101 to M160 are turned on and off with control signals 5101 to 5160 output from the controller CNT1. There may be provided any number other than 60 of the series circuits above. In the configuration example shown in FIG. 7, the combined resistance of the resistors Z101 to Z160 determines the resistance value of the second variable resistance circuit VR2, and this permits accurate control of the resistance value of the second variable resistance circuit VR2.

The second variable resistance circuit VR2 of the first configuration example shown in FIG. 7 further includes dummy switches DSW101 to DSW160, AND gates A101 to A160, and dummy capacitances DC101 to DC160. The dummy switches DSW101 to DSW160 serve as charge adjusters that can absorb and discharge electric charge with respect to the NMOS transistors M101 to M160 respectively. The dummy switch DSW101 is an NMOS transistor of which the source and the drain are short-circuited together and connected to the drain of the NMOS transistor M101. When the NMOS transistor M101 is on, the dummy switch DSW101 can turn on. The AND gate A101 feeds the AND of the control signal 5101 and an adjustment signal ADJ101 to the gate of the dummy switch DSW101. Thus, when the adjustment signal ADJ101 is at high level, the dummy switch DSW101 can absorb and discharge electric charge with respect to the NMOS transistor M101. By contrast, when the adjustment signal ADJ101 is at low level, the dummy switch DSW101 cannot absorb or discharge electric charge with respect to the NMOS transistor M101.

The dummy switches DSW102 to DSW160 and the AND gates A102 to A160 are similar to the dummy switch DSW101 and the AND gate A101, and therefore of those no detailed description will be given.

The dummy capacitances DC101 to DC160 are capacitances that are provided between the gate and the source of the NMOS transistors M101 to M160 respectively. The dummy capacitances DC101 to DC160 are NMOS transistors of which the source and the drain are short-circuited together and connected to the source of the NMOS transistors M101 to M160 respectively. The gate of the dummy capacitances DC101 to DC160 is connected to the gate of the NMOS transistors M101 to M160 respectively.

The controller CNT1 makes the waveforms of the first and second signals SCANH and SCANL smoother by keeping some of the adjustment signals ADJ1 to ADJ60 and ADJ101 to ADJ160 at high level and the rest of them at low level. Which adjustment signals to keep at high or low level can be determined, for example, based on the results of simulations, experiments, or the like. Which adjustment signals to keep at high or low level can be determined, for example, for each kind of product, or for each lot of products, or product by product. The transceiver circuit 4 of the configuration example shown in FIG. 4 can, owing to its including the dummy switches DSW1 to DSW60 and DSW101 to DSW160, give the first and second signals SCANH and SCANL smoother waveforms. It is thus possible to more effectively suppress common-mode noise.

The dummy capacitances DC101 to DC160 compensate for the differences between the gate-source parasitic capacitances of the PMOS transistors M1 to M60 and the gate-source parasitic capacitances of the NMOS transistors M101 to M160 to suppress time lags between the timing of switching of the PMOS transistors M1 to M60 and the timing of switching of the NMOS transistors M101 to M160. Accordingly, the dummy capacitance DC101 can be given a capacitance value based on the ratio of the gate-source parasitic capacitance of the PMOS transistor M1 to the gate-source parasitic capacitance of the NMOS transistor M101. The capacitance values of the dummy capacitances DC102 to DC160 can be set likewise. The transceiver circuit 4 of the configuration example shown in FIG. 4 can, owing to its including the dummy capacitances DC101 to DC160, still more effectively suppress a broken symmetry between the first and second signals SCANH and SCANL. It is thus possible to still more effectively suppress common-mode noise.

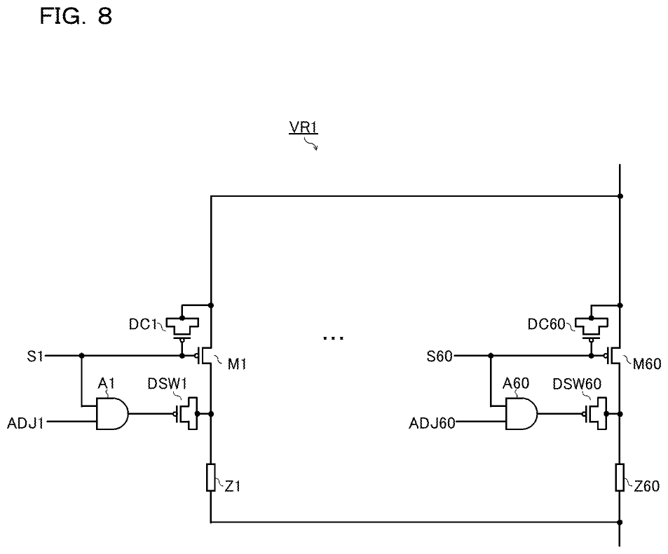

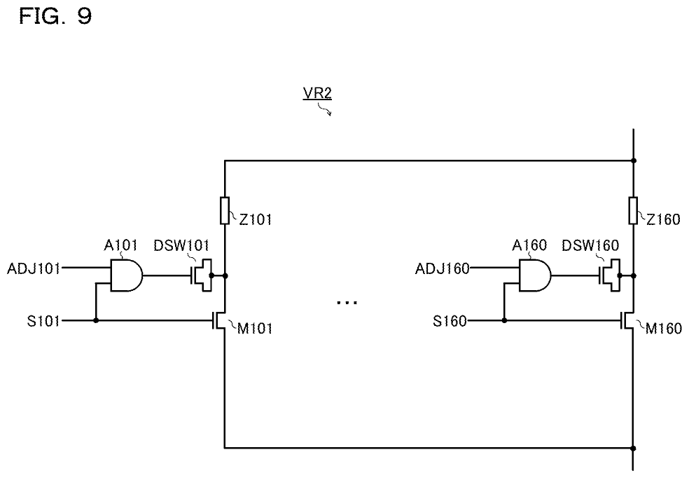

FIG. 8 is a diagram showing a second configuration example of the first variable resistance circuit VR1 and FIG. 9 is a diagram showing a second configuration example of the second variable resistance circuit VR2. The first variable resistance circuit VR1 of the second configuration example shown in FIG. 8 and the second variable resistance circuit VR2 of the second configuration example shown in FIG. 9 are paired in use.

The first variable resistance circuit VR1 of the second configuration example shown in FIG. 8 and the second variable resistance circuit VR2 of the second configuration example shown in FIG. 9 differ from those of the first configuration example in that dummy capacitances are provided not in the second variable resistance circuit VR2 but in the first variable resistance circuit VR1 and are in other respects similar to them.

The first variable resistance circuit VR1 of the second configuration example shown in FIG. 8 includes dummy capacitances DC1 to DC60.

The dummy capacitances DC1 to DC60 are capacitances that are provided between the gate and the source of the PMOS transistors M1 to M60 respectively. The dummy capacitances DC1 to DC60 are NMOS transistors of which the source and the drain are short-circuited together and connected to the source of the PMOS transistors M1 to M60 respectively. The gate of the dummy capacitances DC1 to DC60 are connected to the gate of the PMOS transistors M1 to M60 respectively. The dummy capacitance DC1 can be given a capacitance value based on the ratio of the gate-source parasitic capacitance of the PMOS transistor M1 to the gate-source parasitic capacitance of the NMOS transistor M101. The capacitance values of the dummy capacitances DC2 to DC60 can be set likewise.

The first variable resistance circuit VR1 of the second configuration example shown in FIG. 8 and the second variable resistance circuit VR2 of the second configuration example shown in FIG. 9 provide similar effects as the first variable resistance circuit VR1 of the first configuration example shown in FIG. 6 and the second variable resistance circuit VR2 of the first configuration example shown in FIG. 7.

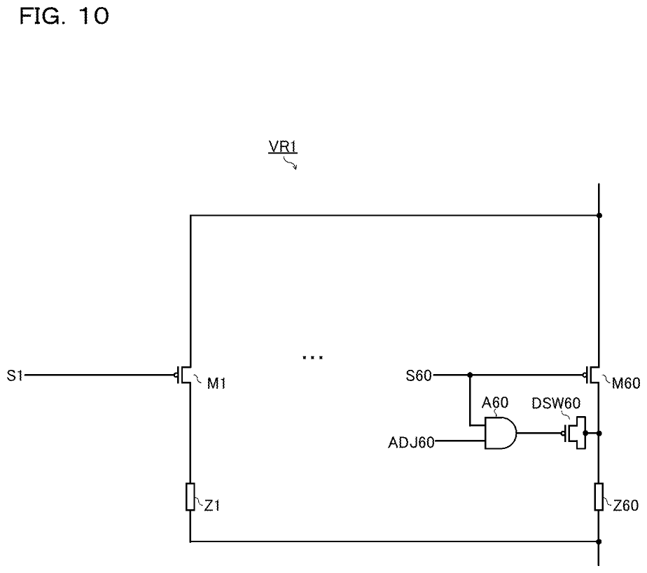

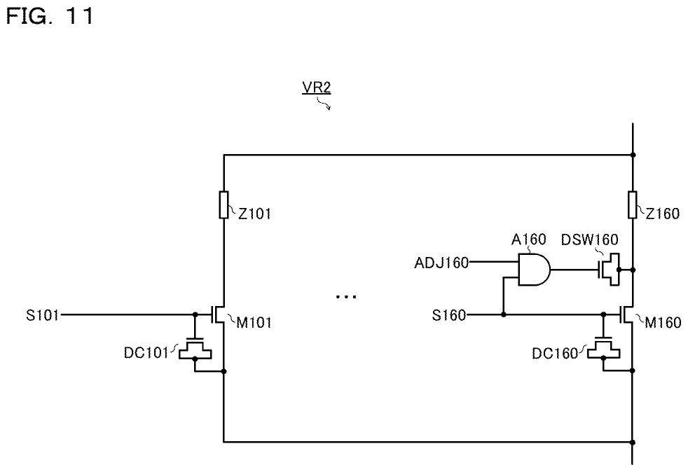

FIG. 10 is a diagram showing a third configuration example of the first variable resistance circuit VR1 and FIG. 11 is a diagram showing a third configuration example of the second variable resistance circuit VR2. The first variable resistance circuit VR1 of the third configuration example shown in FIG. 10 and the second variable resistance circuit VR2 of the third configuration example shown in FIG. 11 are paired in use.

The first variable resistance circuit VR1 of the third configuration example shown in FIG. 10 has a configuration resulting from omitting from the first variable resistance circuit VR1 of the first configuration example shown in FIG. 6 the dummy switches DSW1 to DSW50 and the AND gates A1 to A50. Thus the first variable resistance circuit VR1 of the third configuration example shown in FIG. 10 occupies a smaller circuit area than the first variable resistance circuit VR1 of the first configuration example shown in FIG. 6.

The second variable resistance circuit VR2 of the third configuration example shown in FIG. 11 has a configuration resulting from omitting from the second variable resistance circuit VR2 of the first configuration example shown in FIG. 7 the dummy switches DSW101 to DSW150 and the AND gates A101 to A150. Thus the second variable resistance circuit VR2 of the third configuration example shown in FIG. 11 occupies a smaller circuit area than the second variable resistance circuit VR2 of the first configuration example shown in FIG. 7.

The controller CNT1 turns off the PMOS transistors M1 to M60 one after another, turning off the PMOS transistor M60 last, and turns off the NMOS transistors M101 to M160 one after another, turning off the NMOS transistor M160 last.

The dummy switch DSW60 can absorb and discharge electric charge with respect to the PMOS transistor M60, which is turned off last among the PMOS transistors M1 to M60. Absorbing and discharging electric charge with respect to the PMOS transistor M60, which is turned off last, has a great effect in adjusting the waveforms of the first and second signals SCANH and SCANL. Accordingly, by modifying the first configuration example so as to omit some dummy switches while retaining the dummy switch DSW60, it is possible to reduce the circuit area while minimizing a drop in the effect of waveform adjustment.

The dummy switch DSW160 can absorb and discharge electric charge with respect to the NMOS transistor M160, which is turned off last among the NMOS transistors M101 to M160. Absorbing and discharging electric charge with respect to the NMOS transistor M160, which is turned off last, has a great effect in adjusting the waveforms of the first and second signals SCANH and SCANL. Accordingly, by modifying the first configuration example so as to omit some dummy switches while retaining the dummy switch DSW160, it is possible to reduce the circuit area while minimizing a drop in the effect of waveform adjustment.

<Notes>

The present invention can be implemented with any configuration other than that of the embodiment described above, with any modifications made without departure from the spirit of the present invention. The embodiment described above is to be taken in every way illustrative and not restrictive, and the technical scope of the present invention is defined not by the description of the embodiment given above but by the appended claims and is to be understood to encompass any modifications made within a scope equivalent in significance to what is claimed.

For example, while in the embodiment described above the transceiver circuit performs CAN communication, it may instead perform any communication other than CAN communication.

According to one aspect of what is disclosed herein, a transmission circuit, includes: a first terminal (VCC) configured to have a first voltage applied thereto; a second terminal (CANH); a third terminal (CANL); a fourth terminal (GND) configured to have a second voltage applied thereto, the second voltage being lower than the first voltage; a first variable resistance circuit (VR1) between the first and second terminals, the first variable resistance circuit being configured to be able to vary its resistance value; a second variable resistance circuit (VR2) between the third and fourth terminals, the second variable resistance circuit being configured to be able to vary its resistance value; and a controller (CNT1) configured to control the resistance values of the first and second variable resistance circuits based on transmission data. The first and second variable resistance circuits are each a parallel circuit of a plurality of series circuits of a resistor (Z1 to Z60, Z101 to Z160) and a switch (M1 to M60, N101 to M160). The first variable resistance circuit includes a first charge adjuster (DSW1 to DSW60) configured to absorb and discharge electric charge with respect to at least some of the plurality of switches in the first variable resistance circuit. The second variable resistance circuit includes a second charge adjuster (DSW101 to DSW160) configured to absorb and discharge electric charge with respect to at least some of the plurality of switches in the second variable resistance circuit. (A first configuration.)

With the transmission circuit of the first configuration described above, owing to the controller controlling the resistance values of the first and second variable resistance circuits, it is possible to suppress common-mode noise resulting from a skew through. Moreover, with the transmission circuit of the first configuration described above, owing to its including the first and second charge adjusters, it is possible to more effectively suppress common-mode noise.

In the transmission circuit of the first configuration described above, preferably, the first and second charge adjusters each include at least one first MOS transistor of which the source and the drain are short-circuited together. Preferably, when the switch to which the first MOS transistor is connected is on, the first MOS transistor can turn on.

### (A Second Configuration.)

With the transmission circuit of the second configuration described above, it is possible to reduce the size and the cost of the first and second charge adjusters.

In the transmission circuit of the first or second configuration described above, preferably, the first charge adjuster can absorb and discharge electric charge with respect to, among the plurality of switches in the first variable resistance circuit, the switch that is turned off last, and the second charge adjuster can absorb and discharge electric charge with respect to, among the plurality of switches in the second variable resistance circuit, the switch that is turned off last. (A third configuration.) With the transmission circuit of the third configuration described above, it is possible to reduce the circuit area while suppressing a drop in the effect of waveform adjustment on the signals output from the second and third terminals.

In the transmission circuit of any of the first to third configurations described above, preferably, the first variable resistance circuit includes a capacitance (DC1 to DC60) between the gate and the source of a P-channel MOS transistor as the switch. (A fourth configuration.)

With the transmission circuit of the fourth configuration described above, it is possible to more effectively suppress a broken symmetry between the signals output from the second and third terminals. Thus, with the transmission circuit of the fourth configuration described above, it is possible to more effectively suppress common-mode noise.

In the transmission circuit of any of the first to third configurations described above, preferably, the second variable resistance circuit includes a capacitance (DC101 to DC160) between the gate and the source of an N-channel MOS transistor as the switch.

### (A Fifth Configuration.)

With the transmission circuit of the fifth configuration described above, it is possible to more effectively suppress a broken symmetry between the signals output from the second and third terminals. Thus, with the transmission circuit of the fifth configuration described above, it is possible to more effectively suppress common-mode noise.

In the transmission circuit of the fourth or fifth configuration described above, preferably, the capacitance is a second MOS transistor of which the source and the drain are short-circuited together. (A sixth configuration.)

With the transmission circuit of the sixth configuration described above, it is possible to reduce the size and the cost of the capacitance.

In the transmission circuit of any of the fourth to sixth configurations described above, preferably, the capacitance has a capacitance value based on the ratio of the gate-source parasitic capacitance of a P-channel MOS transistor as the switch in the first variable resistance circuit to the gate-source parasitic capacitance of a P-channel MOS transistor as the switch in the second variable resistance circuit. (A seventh configuration.)

With the transmission circuit of the seventh configuration described above, it is possible to suppress time lags between the timing of switching of the plurality of switches in the first variable resistance circuit and the timing of switching of the plurality of switches in the second variable resistance circuit.

According to another aspect of what is disclosed herein, an electronic control unit (1) includes: the transmission circuit of any of the first to seventh configurations described above; and a computer (3) configured to transmit the transmission data to the transmission circuit. (An eighth configuration.)

With the electronic control unit of the eighth configuration described above, it is possible to suppress common-mode noise in the transmission circuit.

According to yet another aspect of what is disclosed herein, a vehicle (X) includes: a communication bus (BL1, BL2); and the plurality of electronic control units of the eighth configuration described above. (A ninth configuration.)

With the vehicle of the ninth configuration described above, it is possible to suppress common-mode noise in the transmission circuit.

1. A transmission circuit, comprising:
a first terminal configured to have a first voltage applied thereto;
a second terminal;
a third terminal;
a fourth terminal configured to have a second voltage applied thereto, the second voltage being lower than the first voltage;
a first variable resistance circuit between the first and second terminals, the first variable resistance circuit being configured to be able to vary a resistance value thereof;
a second variable resistance circuit between the third and fourth terminals, the second variable resistance circuit being configured to able to vary a resistance value thereof; and
a controller configured to control the resistance values of the first and second variable resistance circuits based on transmission data,
wherein
the first and second variable resistance circuits are each a parallel circuit of a plurality of series circuits of a resistor and a switch,
the first variable resistance circuit includes a first charge adjuster configured to absorb and discharge electric charge with respect to at least some of a plurality of switches in the first variable resistance circuit, and
the second variable resistance circuit includes a second charge adjuster configured to absorb and discharge electric charge with respect to at least some of a plurality of switches in the second variable resistance circuit.

2. The transmission circuit according to claim 1, wherein
the first and second charge adjusters each include at least one first MOS transistor of which a source and a drain are short-circuited together, and
when the switch to which the first MOS transistor is connected is on, the first MOS transistor can turn on.

3. The transmission circuit according to claim 1, wherein
the first charge adjuster can absorb and discharge electric charge with respect to, among the plurality of switches in the first variable resistance circuit, a switch that is turned off last, and
the second charge adjuster can absorb and discharge electric charge with respect to, among the plurality of switches in the second variable resistance circuit, a switch that is turned off last.

4. The transmission circuit according to claim 1, wherein
the first variable resistance circuit includes a capacitance between a gate and a source of a P-channel MOS transistor as the switch.

5. The transmission circuit according to claim 1, wherein
the second variable resistance circuit includes a capacitance between a gate and a source of an N-channel MOS transistor as the switch.

6. The transmission circuit according to claim 4, wherein
the capacitance is a second MOS transistor of which a source and a drain are short-circuited together.

7. The transmission circuit according to claim 5, wherein
the capacitance is a second MOS transistor of which a source and a drain are short-circuited together.

8. The transmission circuit according to claim 4, wherein
the capacitance has a capacitance value based on a ratio of a gate-source parasitic capacitance of a P-channel MOS transistor as the switch in the first variable resistance circuit to a gate-source parasitic capacitance of a P-channel MOS transistor as the switch in the second variable resistance circuit.

9. The transmission circuit according to claim 5, wherein
the capacitance has a capacitance value based on a ratio of a gate-source parasitic capacitance of a P-channel MOS transistor as the switch in the first variable resistance circuit to a gate-source parasitic capacitance of a P-channel MOS transistor as the switch in the second variable resistance circuit.

10. An electronic control unit, comprising:
the transmission circuit according to claim 1; and
a computer configured to transmit the transmission data to the transmission circuit.

11. A vehicle, comprising:
a communication bus; and
the plurality of electronic control units according to claim 10 connected to the communication bus.
